(19) United States
(12) Patent Application Publication
(10) Pub. No.: US 2025/0217812 A1
(43) Pub. Date: Jul. 3, 2025

(54) Methods, Systems, and Electronic Devices for Presenting Secondary Confirmation Challenges for Electronic Payment Transactions

(71) Applicant: Motorola Mobility LLC, Chicago, IL (US)

(72) Inventors: Krishnan Raghavan, Bangalore (IN); Rahul Sahadevan, Nagpur (IN); Nakul Patel, Ernakulam Cochin (IN)

(21) Appl. No.: 18/402,570

(22) Filed: Jan. 2, 2024

(51) Int. Cl. G06Q 20/42; G06Q 20/38

(52) U.S. Cl. CPC G06Q 20/42; G06Q 20/388

(57) ABSTRACT

A method in an electronic device includes receiving user input requesting an electronic payment transaction. The electronic payment transaction defines an electronic payment transaction amount. One or more processors of the electronic device determine whether the electronic payment transaction amount triggers a secondary confirmation operation. Where it does, the one or more processors present a prompt that includes a secondary confirmation challenge. When user input correctly answers the secondary confirmation challenge, the one or more processors complete the electronic payment transaction. However, when the user input answering the secondary confirmation challenge incorrectly answers the secondary confirmation challenge, the one or more processors preclude completion of the electronic payment transaction.

### BACKGROUND

### Technical Field

This disclosure relates generally to electronic payment transaction systems, and more particularly to electronic devices operable to initiate electronic payment transactions in such systems.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

While such electronic devices offer lightning-fast convenience of operation, the fact that data can be entered and transmitted so quickly and effortlessly can lead to the occurrence of mistakes. When there is time pressure to complete a task, a mistake in data entry can snowball into problems that are difficult to fix. It would be advantageous to have improved electronic devices and methods that reduce the number of mistakes that occur when using devices to perform tasks.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates one explanatory electronic device in accordance with one or more embodiments of the disclosure.

FIG. 5 illustrates another electronic device in accordance with one or more embodiments of the disclosure.

FIG. 6 illustrates one or more embodiments of the disclosure.

FIG. 7 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, using one or more processors of an electronic device, whether an electronic payment transaction amount triggers a secondary confirmation challenge and, when the electronic payment transaction amount triggers the secondary confirmation challenge, presenting a prompt on a user interface comprising a secondary confirmation challenge. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to a user interface receiving user input requesting an electronic payment transaction and defining an electronic payment transaction amount, presenting a secondary confirmation challenge questioning the electronic payment transaction amount and precluding the electronic payment transaction from occurring when other user input received by the user interface in response to the presentation of the secondary confirmation challenge fails the secondary confirmation challenge as described herein. The non-processor circuits may include, but are not limited to, a radio receiver, a radio transmitter, signal drivers, clock circuits, power source circuits, and user input devices.

As such, these functions may be interpreted as steps of a method to perform the determination, by one or more processors, whether an electronic payment transaction amount defined by user input received by a user interface meets a predefined criterion and, when it does, presenting a secondary confirmation challenge requiring other user input at the user interface re-entering the electronic payment transaction amount in a different format. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, portable electronic devices such as smartphones are frequently used for banking operations and financial transactions. Illustrating by example, Motorola Mobility has launched a banking application called DIMO.sup.TM in Brazil. Digital banking applications such as DIMO.sup.TM are redefining banking. Indeed, DIMO.sup.TM already has more than one hundred thousand users of the system in Brazil and expects for that number to only continue to grow.

This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.TM are leading to users simply ceasing to carry paper currency or coins. Moreover, applications like DIMO.sup.TM have caused people to stop carrying physical credit and debit cards as well since the credit and debit card account information can simply be loaded into a smartphone, with near field and other communication devices allowing direct transactions of money electronically.

Banking applications such as DIMO.sup.TM allow people to perform banking operations very quickly. The fact that money can be moved instantaneously provides great convenience and saves banking customers large amounts of time. Indeed, as the recent collapse of Silicon Valley Bank (SVB) indicates, customers can move large sums of money nearly instantaneously using nothing more than a smartphone. In the bank run triggered by a bond sale that took a significant loss, a whopping forty-two billion dollars was withdrawn from the bank in a single day on Mar. 9, 2023.

While this ability to make payments and transfer money is convenient, embodiments of the disclosure contemplate that mistakes can lead to problems that are difficult to fix. Illustrating by example, if a person is trying to electronically transfer eight dollars and instead transfers eight hundred dollars, in addition to the personal embarrassment the person may feel for the mistake, retrieving the erroneous seven hundred and ninety-two dollars may be difficult or impossible.

Embodiments of the disclosure contemplate that such mistakes can be made for a variety of reasons. Examples include times when a user is under time pressure to make a payment, carelessness of data entry by a user or a merchant, intentional manipulation of data by a nefarious actor, confusion by a user as to the amount that may be due, simple typographical errors, or even medical conditions such as dyslexia, blurred vision, and so forth. Regardless of cause, when data errors occur during electronic payment transactions, a user can end up transferring or paying an incorrect amount. These errors cost lost time at a minimum to correct and may end up resulting in loss of capital as well.

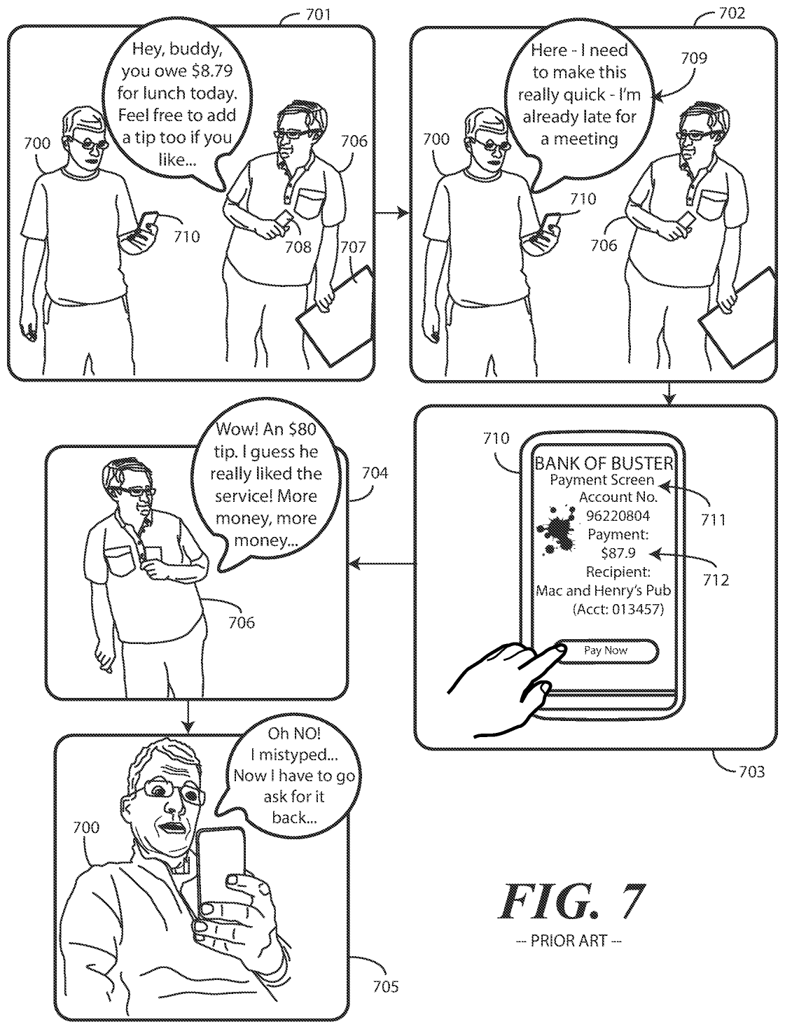

To illustrate how problematic this can be, turn now to FIG. 7, where a prior art method is shown. Beginning at step 701, a restaurant worker 706 holding a menu 707 is asking a patron 700 to transfer eight dollars and seventy-nine cents in an electronic payment transaction initiated by the patron's electronic device 710. Specifically, the restaurant worker 706 is asking the patron 700 to initiate an electronic payment transaction using his electronic device 710 that has an electronic payment transaction amount of eight dollars and seventy-nine cents to a point-of-sale device 708 belonging to the restaurant, which is Mac and Henry's Pub.

At step 702, the patron 700 obliges by initiating an electronic payment transaction using his electronic device 710. However, the patron 700 notes 709 that he must make this very quick because the patron 700 is already late for a meeting, which the restaurant worker 706, who is also “in the weeds” as they say in the restaurant business, understands. It is for this reason the restaurant worker 706 noted that tips would be appreciated at step 701.

As shown at step 703, the patron 700 delivers user input to the electronic device 710 initiating an electronic payment transaction 711 from the Bank of Buster. As shown, the electronic payment transaction 711 defines an electronic payment transaction amount 712. However, due to the time pressure felt by the patron 700, rather than delivering user input to the electronic device 710 defining the electronic payment transaction amount 712 to be $8.79, the patron 700 mistypes the decimal point and defines the electronic payment transaction amount 712 to be $87.90, which is ten times the amount due. The patron 700 then hastily leaves Mac and Henry's Pub, satisfied by another delicious meal that has become so dependable at this storied eating establishment.

As shown at step 704, the restaurant worker 706 thinking that it was instead the patron 700 who really understood the restaurant worker's busy day, decided to be extra generous. The restaurant worker 706 is dumbfounded that the patron 700 was nice enough to leave nearly an eighty-dollar tip. Sadly, as shown at step 705, this was just an inadvertent accident. As shown at step 705, the patron 700 is now embarrassed and considerably poorer. He is left with the choice of losing the money all together or going back to have to ask the restaurant worker 706 to give some of the money back—money that has probably been already spent on lavish dinners and fancy wine. After all, restaurant workers need to relax as well. While the poor patron 700 vows to be more careful with electronic payment transaction amounts in the future, this does nothing to retrieve the over seventy dollars he accidentally transferred to the restaurant worker 706.

Now consider another example: Imagine Nakul is on a long drive on an Interstate Highway in India. While driving, he stops by a roadside business to taste some tender coconuts. The merchant shows Nakul a “Value Encoded QR Code” on his smartphone and instructs Nakul to scan the code so as to initiate an electronic payment transaction. Blinded by the sweet, tender goodness of the coconuts, Nakul scans the QR code and heads on down the highway.

As he checks into his hotel later than night, Nakul realizes that the “Value Encoded QR Code” caused his bank account to be debited thirty-eight hundred rupees rather than three hundred and eighty rupees. While his coconuts were sweet and tasty, the merchant was clearly a crook. However, given how far his hotel is from the roadside stand, which may not even be there any more given the merchant's tendency to act nefariously, Nakul understands that there will be very little chance for him to correct the situation. While he wonders if the overcharge was an honest mistake, deep down Nakul feels that the merchant intentionally fleeced him. Regardless, Nakul knows he should have paid more attention to the electronic payment transaction amount.

Advantageously, embodiments of the disclosure provide a solution to this problem. Indeed, in one or more embodiments methods, systems, and electronic devices configured in accordance with embodiments of the disclosure actively request users to confirm their electronic payment transaction amount using different “challenge” techniques.

In one or more embodiments, one or more processors of an electronic device determine whether an electronic payment transaction defining an electronic payment transaction amount requires a challenge. This determination can be based upon a variety of factors, the number and combination of which is user-definable in one or more embodiments. Examples include whether the electronic payment transaction amount exceeds a predefined threshold, whether the one or more processors detect an unusually high electronic payment transaction amount, a time of day when the electronic payment transaction amount is requested (e.g., late night, early morning), location where the electronic payment transaction amount is defined (e.g., pubs, crowded places), and business-specific factors such as whether the business to which the electronic payment transaction will be made is known or unknown to the user and/or electronic device (for instance, whether the recipient is a favorite or frequent contact on user's bank account, or if there is a history of transactions with this recipient). Other factors or ways of determining whether an electronic payment transaction amount requires a challenge will be described below. Still others will be obvious to those of ordinary skill in the art having the benefit of this disclosure.

In one or more embodiments, when a challenge is required, one or more processors of the electronic device challenge the user to confirm the amount. If the user succeeds in addressing the challenge, the electronic device allows the electronic payment transaction to complete. However, if the user fails the challenge, the one or more processors can either present a different challenge or preclude the electronic payment transaction from completing. In one or more embodiments, if the user fails a predetermined number of times, the one or more processors will cancel the electronic payment transaction and request that the user start over with the electronic payment transaction's initiation.

In one or more embodiments, a method in an electronic device receives, at a user interface, user input requesting an electronic payment transaction and defining an electronic payment transaction amount. In one or more embodiments, the method comprises determining, by one or more processors, whether the electronic payment transaction amount triggers a secondary confirmation operation. When the electronic payment transaction amount triggers the secondary confirmation operation, in one or more embodiments the method comprises presenting, by the one or more processors on the user interface, a prompt comprising a secondary confirmation challenge.

In one or more embodiments, when user input answering the secondary confirmation challenge correctly answers the secondary confirmation challenge, the one or more processors complete the electronic payment transaction. However, when the user input answering the secondary confirmation challenge incorrectly answers the secondary confirmation challenge, in one or more embodiments the one or more processors preclude completion of the electronic payment transaction.

The secondary confirmation challenges can vary. In one or more embodiments, the secondary confirmation challenge requests that the electronic payment transaction amount be entered in words. In other embodiments, the secondary confirmation challenge lists a plurality of user selectable amounts spelled out in words, with one user selectable amount of the plurality of user selectable amounts spelling out the electronic payment transaction amount in the words and other user selectable amounts of the plurality of user selectable amounts spelling out transaction amounts other than the electronic payment transaction amount in the words. The user must then select the proper electronic payment transaction amount from the list.

In still other embodiments, the secondary confirmation challenge lists a plurality of user selectable math equations with one user selectable math equation of the plurality of user selectable math equations has a sum equal to the electronic payment transaction amount, while other user selectable math equations of the plurality of user selectable math equations have other sums that are different from the electronic payment transaction amount. The user must then select the proper math equation for the electronic payment transaction to be allowed to proceed. Other secondary confirmation challenges will be described below. Still others will be obvious to those of ordinary skill in the art having the benefit of this disclosure.

Just as the secondary confirmation challenge can vary, so too can the criteria triggering the secondary confirmation operation. Illustrating by example, in one or more embodiments determining whether the electronic payment transaction amount triggers the secondary confirmation operation comprises determining whether eth electronic payment transaction amount exceeds a predefined threshold. In other embodiments, determining whether the electronic payment transaction amount triggers a secondary confirmation operation comprises determining whether the electronic payment transaction amount exceeds a predetermined average electronic payment transaction amount.

In still other embodiments, determining whether the electronic payment transaction amount triggers a secondary confirmation operation comprises determining whether the electronic payment transaction amount is requested while the electronic device is situated in a predefined location. Other techniques for determining whether the electronic payment transaction amount triggers a secondary confirmation operation will be described below, while still others will be obvious to those of ordinary skill in the art having the benefit of this disclosure.

In one or more embodiments, an electronic device comprises a user interface, a communication device, and one or more processors operable with the user interface and the communication device. In one or more embodiments, the one or more processors are configured to, in response to the user interface receiving user input requesting an electronic payment transaction and defining an electronic payment transaction amount, present a secondary confirmation challenge questioning the electronic payment transaction amount. In one or more embodiments, the one or more processors preclude the electronic payment transaction form occurring with other user input received by the user interface in response to presentation of the secondary confirmation challenge fails the secondary confirmation challenge.

In one or more embodiments, a method in an electronic device comprises receiving, by a user interface, user input defining an electronic payment transaction amount. In one or more embodiments, the method comprises determining, by one or more processors operable with the user interface, whether the electronic payment transaction amount meets a predefined criterion.

In one or more embodiments, when the electronic payment transaction amount meets the predefined criterion, the method comprises presenting, by the one or more processors on the user interface, a secondary confirmation challenge requiring other user input at the user interface re-entering the electronic payment transaction amount in a different format. Embodiments of the disclosure contemplate that while some prior art systems may present a prompt with a question such as “are you sure” in response to initiation of an electronic payment transaction, these are neither secondary confirmation challenges nor effective. They are not secondary confirmation challenge because they do not require confirmation of the electronic payment transaction amount. Moreover, they are not effective in that users more often than not proceed by just clicking “next” or “yes” without reading the prompt. Embodiments of the disclosure are distinct because the secondary confirmation challenges require some form of confirmation of the electronic payment transaction amount in a different format, which these prior art systems do not.

In one or more embodiments, the method comprises precluding execution of the electronic payment transaction associated with the electronic payment transaction amount when the other user input fails to re-enter the electronic payment transaction amount in the different format. Examples of such different formats include entering the electronic payment transaction amount in words or in math equations, although other alternate formats will be obvious to those of ordinary skill in the art having the benefit of this disclosure.

Advantageously, embodiments of the disclosure alert the user and actively require a re-confirmation of an electronic payment transaction amount based upon predefined limits, historical context, locational context, or other factors. It prevents the sad situation from FIG. 7 from happening. Other advantages will be described below. Still others will be obvious to those of ordinary skill in the art having the benefit of this disclosure.

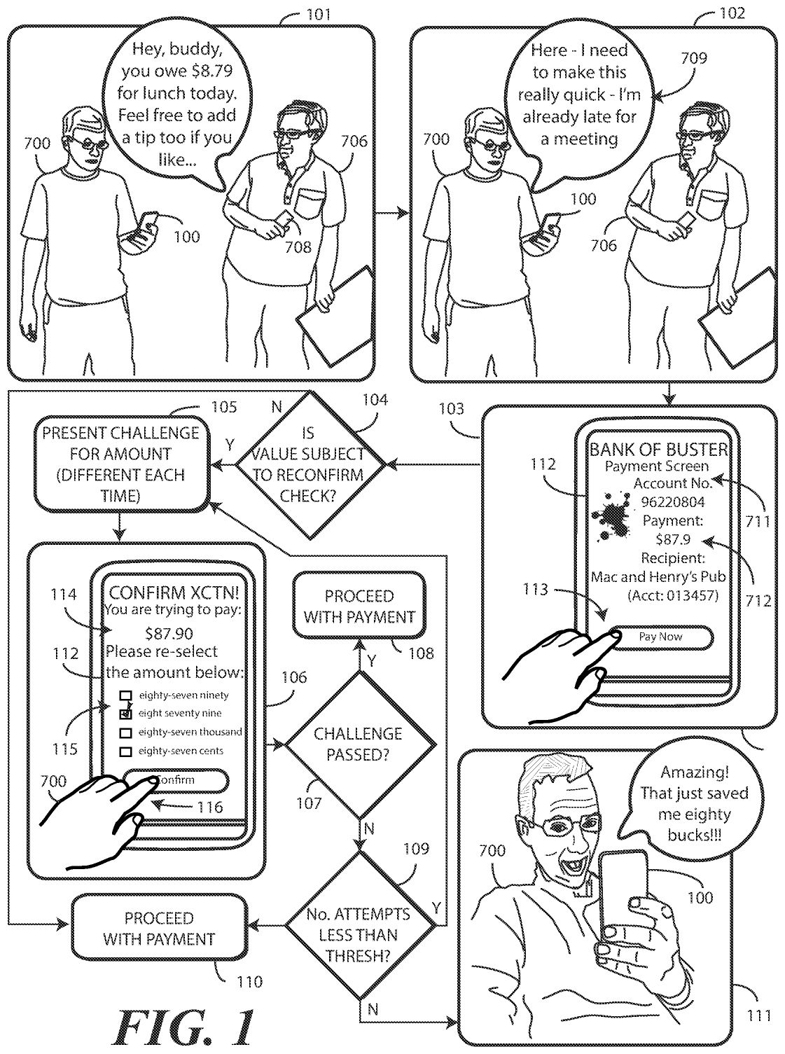

To see how embodiments of the disclosure can operate, turn now to FIG. 1. Beginning at step 101, our friendly restaurant worker 706 is once again asking our satiated patron 700 to transfer eight dollars and seventy-nine cents in an electronic payment transaction. However, in FIG. 1, rather than trying to use the prior art electronic device (710) of FIG. 7, the patron 700 is armed with an electronic device 100 configured in accordance with one or more embodiments of the disclosure. Accordingly, the restaurant worker 706 is asking the patron 700 to initiate an electronic payment transaction using an electronic device 100 configured in accordance with one or more embodiments of the disclosure by defining an electronic payment transaction amount of eight dollars and seventy-nine cents. This electronic payment transaction will be directed to the point-of-sale device 708 belonging to Mac and Henry's Pub.

Once again, at step 102, the patron 700 obliges by initiating an electronic payment transaction using this electronic device 100 that is configured in accordance with one or more embodiments of the disclosure. Unfortunately, the patron 700 is again in a hurry, noting 709 that he must make this very quick because the patron 700 is already late for a meeting. Our restaurant worker 706 is still “in the weeds” and notes that tips would again be appreciated.

Due to this time pressure, the patron 700 once again delivers errant user input to the electronic device 100 when initiating an electronic payment transaction 711 from the Bank of Buster. As shown, the electronic payment transaction 711 defines an electronic payment transaction amount 712. Due to carelessness and time pressure, rather than delivering user input to the electronic device 100 defining the electronic payment transaction amount 712 to be $8.79, the patron 700 again mistypes the decimal point and defines the electronic payment transaction amount 712 to be $87.90, which is ten times the amount due.

At step 103, the user interface 112 of the electronic device 100, which is a touch-sensitive display in this example, receives user input 113 requesting the electronic payment transaction 711 and defining the electronic payment transaction amount 712. Decision 104 then determines, using one or more processors of the electronic device 100, whether the electronic payment transaction amount 712 triggers a secondary confirmation operation.

This determination made at decision 104 can be done in a variety of ways. In one or more embodiments, determining whether the electronic payment transaction amount 712 triggers a secondary confirmation operation comprises determining whether the electronic payment transaction amount 712 exceeds a predefined threshold. Illustrating by example, in one or more embodiments the patron 700 can use a menu and settings controls to define a predefine threshold, say, a thousand dollars for example, above which any electronic payment transaction would require a secondary confirmation operation.

In other embodiments, determining whether the electronic payment transaction amount 712 triggers a secondary confirmation operation comprises determining whether the electronic payment transaction amount 712 exceeds a predetermined average electronic payment transaction amount. For instance, if the patron 700 routinely uses the electronic device 100 to make electronic payment transactions, the one or more processors of the electronic device 100 can keep a running average of transactions, optionally with filters to eliminate outliers.

In one or more embodiments, the calculation of running average can also take into consideration additional factors like location, time of the day, recipient, and so forth, to provide a tailored running average specific to the context of the given situation. In one or more embodiments, when the user's transaction history is not available or sufficient, overall or for the given context, calculation of running average can also be based on the shared data of one or more other users with similar user profile. In one or more embodiments, when the electronic payment transaction amount 712 exceeds this running average, the one or more processors can determine that a secondary confirmation operation is required.

In still other embodiments, determining whether the electronic payment transaction amount 712 triggers a secondary confirmation operation comprises determining whether the electronic payment transaction 711 is requested at a predetermined time of day. Embodiments of the disclosure contemplate that when it is very early the patron 700 may be a bit groggy. Similarly, when it is very late the patron 700 may be tired or may have had a glass of wine with dinner, thereby compromising his concentration. Accordingly, in one or more embodiments a secondary confirmation operation is required when the electronic payment transaction 711 is requested at a predetermined time of day. In one or more embodiments, the predetermined times of day, or ranges of time during which secondary confirmation operations are required can be defined using user settings of the electronic device 100.

In still other embodiments, determining whether the electronic payment transaction amount 712 triggers a secondary confirmation operation comprises determining whether the electronic payment transaction is requested while the electronic device is situated in a predefined location. Recall the example above where Nakul was enjoying sweet, tasty coconuts purchased from a street-side vendor on the side of the highway. Since this location is not associated with a permanently situated merchant, in one or more embodiments a secondary confirmation operation would be triggered. The locations triggering secondary confirmation operations can be defined by the user, defined by predefined merchant locations known on public maps, and so forth. In other embodiments, the predefined location may be a bar or restaurant where the patron 700 may be consuming alcohol or other substances that may impair their ability to define the electronic payment transaction amount 712. When the electronic device 100 is situated in such locations when the user input 113 defining the electronic payment transaction 711 is received, in one or more embodiments cause a secondary confirmation operation to be triggered. Alternatively, in case of predetermined locations, user may define the safe locations which does not require secondary confirmation challenge and any location outside these predetermined location will trigger the secondary confirmation challenge.

In still other embodiments, determining whether the electronic payment transaction amount 712 triggers a secondary confirmation operation comprises determining whether the electronic payment transaction 711 is directed to a recipient to whom previous electronic payment transactions have occurred. In this example, our patron 700 dines at Mac and Henry's Pub three to five times a week. Accordingly, the one or more processors of the electronic device 100 and the Bank of Buster have historical logs indicating that Mac and Henry's Pub is a frequented location and, perhaps, is even a trusted merchant. However, Nakul's crooked coconut vendor was a one-off transaction with a vendor with whom Nakul had never done business. In one or more embodiments, decision 104 would trigger a secondary confirmation operation for the coconut vendor but would not trigger one for Mac and Henry's Pub because the latter is a recipient whom previous electronic payment transactions have occurred. However, since no previous electronic payment transactions had occurred with the coconut vendor, Nakul, and the poor guy been carrying an electronic device configured in accordance with embodiments of the disclosure, would have received a secondary confirmation challenge from a secondary confirmation operation.

It should be noted that these examples of how decision 104 could determine whether a secondary confirmation operation is triggered could be used alone or in combination. Additionally, these examples are illustrative only, as others will be obvious to those of ordinary skill in the art having the benefit of this disclosure.

In this example, decision 104 determines whether a secondary confirmation operation is triggered by comparing the electronic payment transaction amount 712 with a running average of electronic payment transactions occurring with this particular merchant, namely, Mac and Henry's Pub. As noted above, our patron 700 dines at Mac and Henry's Pub, which specializes in Champagne and burger specials daily. His typical meal is the bubble burger de jour, which is a four ounce pour of sparkling wine with a burger cooked medium rare with extra pickles. Since Mac and Henry's Pub is a fair merchant trying to deliver excellent quality for a moderate price, this typically runs in the ten-to-twelve-dollar range. Today, our patron 700 stepped out of his comfort zone and tried the Cava Cheeseburger experience. As Cava is generally less expensive than Champagne, the tab was only eight dollars and seventy-nine cents.

Thus, at decision 104 the one or more processors of the electronic device 100 compare the electronic payment transaction amount 712 to an average of electronic payment transactions transacted with Mac and Henry's Pub. Had the patron 700 entered the correct amount, decision 104 would have determined no secondary confirmation operation was necessary because $8.79 is less than the ten-to-twelve-dollar average. Step 110 would have then transferred the eight dollars and seventy-nine cents to the point-of-sale device 708.

However, since the patron 700 did not enter the proper amount, decision 104 determines that eighty-seven dollars and ninety cents is way over the ten-to-twelve-dollar average of past electronic payment transactions with Mac and Henry's Pub. Accordingly, at step 105 the one or more processors of the electronic device 100 present a prompt comprising a secondary confirmation challenge. One example of such a prompt 114 and secondary confirmation challenge 115 is shown at step 106.

The secondary confirmation challenge 115 can take a variety of forms. In one or more embodiments, the secondary confirmation challenge 115 requires other user input 116 at the user interface 112 re-entering the electronic payment transaction amount 712 in a different format. Illustrating by example, the secondary confirmation challenge 115 of step 105 lists a plurality of user selectable amounts spelled out in words. One of the user selectable amounts spells out the electronic payment transaction amount 712 in the words, while other user selectable amounts of the plurality of user selectable amounts spell out transaction amounts other than the electronic payment transaction amount 712 in the words. This allows the patron 700 to deliver the other user input 116 selecting the electronic payment transaction amount 712 from the list to correctly answer the secondary confirmation challenge 115.

However, in other embodiments the secondary confirmation challenge 115 will take different forms. Illustrating by example, in another embodiment the secondary confirmation challenge 115 requests that the user type in the electronic payment transaction amount 712 in words. In still other embodiments, the secondary confirmation challenge 115 lists a plurality of user selectable math equations, with one user selectable math equation the plurality of user selectable math equations has a sum equal to the electronic payment transaction amount and other user selectable math equations of the plurality of user selectable math equations have other sums that are different from the electronic payment transaction amount. In still other embodiments, the secondary confirmation challenge 115 requests user to enter the electronic payment transaction amount 712 via audio.

In many embodiments, the secondary confirmation challenge 115 presents a list of user selectable options with only one user selectable option of the list corresponding to the electronic payment transaction amount 712, as is the case at step 105. In one or more embodiments, the secondary confirmation challenge 115 is different for each electronic payment transaction amount 712. Other examples of secondary confirmation challenges 115 will be obvious to those of ordinary skill in the art having the benefit of this disclosure.

Once step 106 receives, at the user interface 112, the other user input 116 answering the secondary confirmation challenge 115, decision 107 determines whether the secondary confirmation challenge 115 was correctly answered. When decision 107 determines that the user input 116 answering the secondary confirmation challenge 115 correctly answers the secondary confirmation challenge 115, the one or more processors of the electronic device 100 complete, at step 108, the electronic payment transaction 711. However, in one or more embodiments, when decision 107 determines that the user input 116 answering the secondary confirmation challenge 115 incorrectly answers the secondary confirmation challenge 115 the one or more processors of the electronic device 100 preclude the completion of the electronic payment transaction 711.

In one or more embodiments, optional decision 109 gives the patron 700 another chance to correctly answer a secondary confirmation challenge when the initial secondary confirmation challenge 115 is failed. Said differently, in one or more embodiments the one or more processors of the electronic device 100 are further configured to present, on the user interface 112, another secondary confirmation challenge when the other user input 116 received by the user interface 112 in response to presentation of the secondary confirmation challenge 115 fails the secondary confirmation challenge 115.

In one or more embodiments, however, this process does not last forever. Accordingly, decision 109 determines whether a predefined number of secondary confirmation challenges has been exceeded by presentation of the prompt 114 comprising the secondary confirmation challenge 115. In one or more embodiments, the preclusion of allowing the electronic payment transaction 711 to complete occurs only when the predefined number of secondary confirmation challenges has not been exceeded by the presentation of the prompt 114 comprising the secondary confirmation challenge 115. In one or more embodiments, when the predefined number of secondary confirmation challenges is exceeded by the presentation of the prompt 114 comprising the secondary confirmation challenge 115, the method of FIG. 1 can return to step 105 where another prompt and another secondary confirmation challenge can be presented. In one or more embodiments, each secondary confirmation challenge that is presented is different from any previously presented secondary confirmation challenge.

In this illustrative example, the other user input 116 answering the secondary confirmation challenge 115 fails to correctly answer the secondary confirmation challenge 115. To wit, the electronic payment transaction amount 712 is $87.90, while the other user input 116 selected an electronic payment transaction amount of $8.79, thereby failing the secondary confirmation challenge 115. Accordingly, at step 111 the one or more processors of the electronic device 100 preclude completion of the electronic payment transaction 711. As shown, the patron 700 is delighted, as the electronic device 100 has just saved him nearly eighty bones by detecting his errant definition of the electronic payment transaction amount 712 and precluding the electronic payment transaction 711 from occurring. The patron 700 is therefore able to re-initiate the electronic payment transaction 711 with the correct electronic payment transaction amount.

In one or more other embodiments, when the user provides the wrong answer to secondary confirmation challenge, then alternatively, system can also update the electronic transaction payment to one of the amount selected (entered) by the user upon confirmation and proceed with the payment. Such an embodiment helps in not only identifying/preventing the mistake but also correcting the mistake and still making the payment seamless.

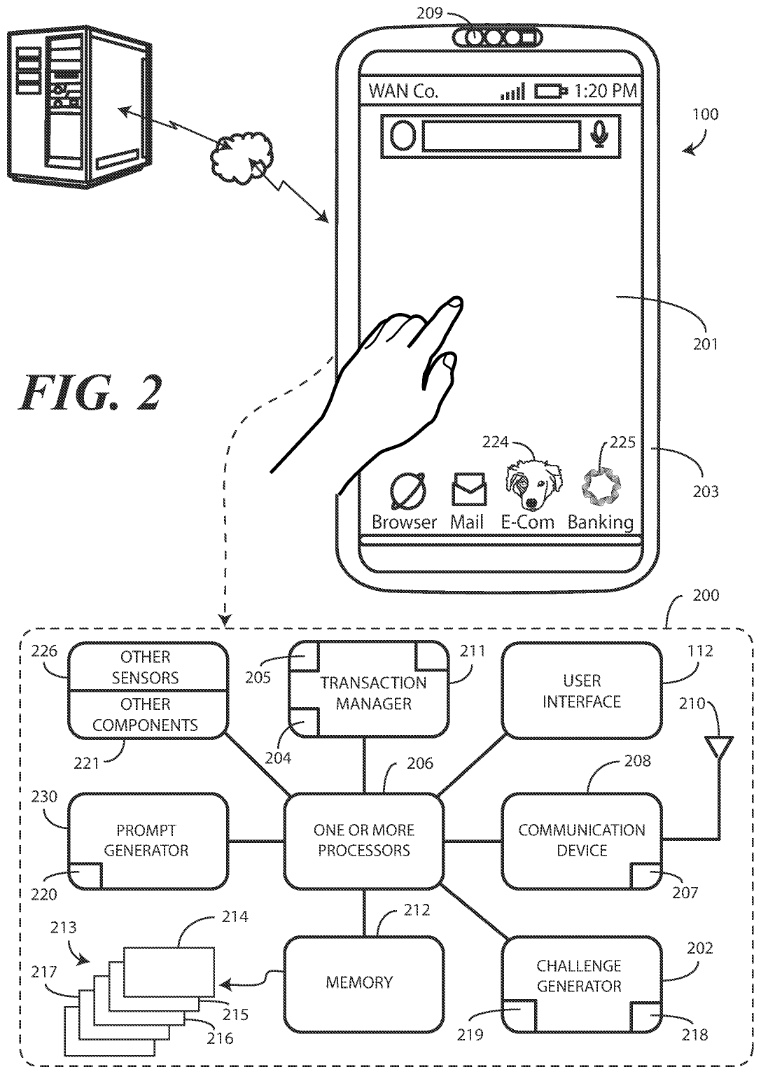

Turning now to FIG. 2, illustrated therein is one electronic device 100 configured in accordance with one or more embodiments of the disclosure. The electronic device 100 of this illustrative embodiment includes a user interface 112. In one or more embodiments, the user interface 112 comprises a display 201, which may optionally be touch-sensitive. The display 201 can serve as a primary user interface 112 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.” In one or more embodiments, these applications comprise one or more e-commerce applications 224 and/or banking applications 225 that allow electronic commerce orders to be placed and financial transactions to be made using the electronic device 100.

Illustrating by example, in one or more embodiments a user can deliver user input to an e-commerce application 224 or a banking application 225 to enter an electronic payment transaction 204 request defining an electronic payment transaction amount 205 or otherwise request an electronic payment transaction occur. In one or more embodiments, when this occurs, the one or more processors 206 are configured to present a secondary confirmation challenge 218 generated by a challenge generator 202 questioning the electronic payment transaction amount 205.

In one or more embodiments, the secondary confirmation challenge 218 presents a list 219 of user selectable options with only one user selectable option of the list 219 corresponding to the electronic payment transaction amount 205. In one or more embodiments, the user selectable options comprise electronic payment transaction amounts spelled out in words. In other embodiments, the user selectable options comprise math equations. Other user selectable options will be obvious to those of ordinary skill in the art having the benefit of this disclosure.

In one or more embodiments, when other user input received by the user interface 112 in response to the presentation of the secondary confirmation challenge 218 fails the secondary confirmation challenge 218, the one or more processors 206 are configured to preclude the electronic payment transaction 204 from occurring, as previously described.

In one or more embodiments, the one or more processors 206 are responsible for managing the applications and all personal information received from the user interface 112 that is to be used by the e-commerce application 224 and/or banking application 225 after the electronic device 100 is authenticated as a secure electronic device and the user identification credentials have triggered an electronic payment transaction request 204. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 100 is reported stolen or when the e-commerce application 224 and/or banking application 225 are used with fraudulent activity to wipe the memory 212 clean of any personal data, preferences, or settings of the person previously using the electronic device 100.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, the electronic device 100 comprises a prompt generator 230 as well. In one or more embodiments, the prompt generator generates a prompt 220 comprising a secondary confirmation challenge 218 when a secondary confirmation operation is triggered. Illustrating by example, the one or more processors 206 can present, on the user interface 112, a prompt 220 generated by the prompt generator 230 comprising a secondary confirmation challenge 218 requiring other user input at the user interface 112 re-entering the electronic payment transaction amount 205 in a different format, such as in different words, via math equations, via selection from a list 219, or by other techniques.

In one or more embodiments, the electronic device 100 also includes a transaction manager 211. In one or more embodiments, the transaction manager 211 and the prompt generator 230 can be operable with one or more processors 206, configured as a component of the one or more processors 206, or configured as one or more executable code modules operating on the one or more processors 206. In other embodiments, the transaction manager 211 and the prompt generator 230 can be standalone hardware components operating executable code or firmware to perform their functions. Other configurations for the transaction manager 211 and the prompt generator 230 will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

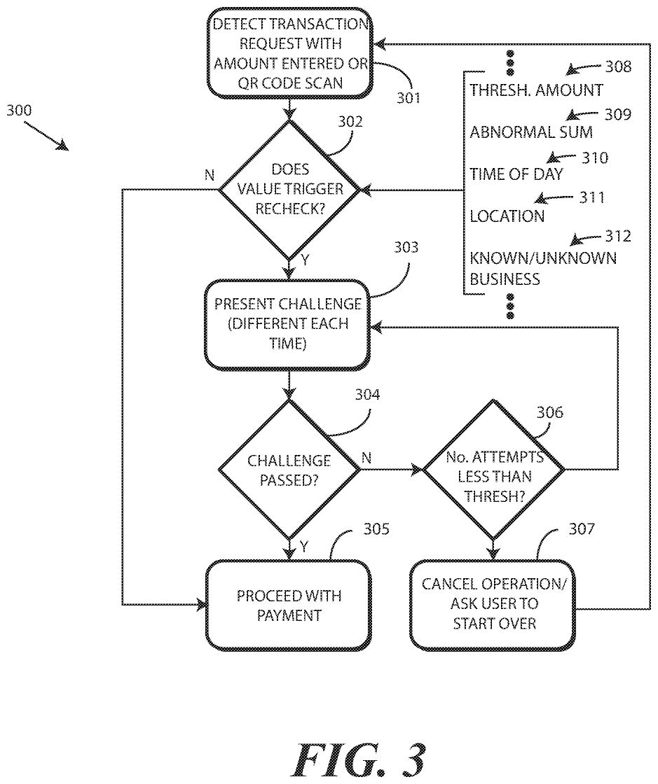

Turning now to FIG. 3, illustrated therein is one explanatory method 300 in accordance with one or more embodiments of the disclosure. Beginning at step 301, the method 300 receives, by a user interface, either user input or a QR-code scan or payment link defining an electronic payment transaction amount. Decision 302 then determines, by one or more processors operable with the user interface, whether the electronic payment transaction amount meets a predefined criterion triggering a secondary confirmation operation. Where no secondary confirmation operation is triggered, step 305 completes the electronic payment transaction.

Examples of such criteria include one or more of whether the electronic payment transaction amount exceeds a predefined threshold 308, whether the electronic payment transaction amount exceeds a predetermined average electronic payment transaction amount 309, whether the electronic payment transaction is requested at a predetermined time of day 310, whether the electronic payment transaction is requested while the electronic device is situated in a predefined location 311, and whether the electronic payment transaction is directed to a recipient 312 to whom previous electronic payment transactions have occurred. Others will be obvious to those of ordinary skill in the art having the benefit of this disclosure.

Where the electronic payment transaction amount triggers a secondary confirmation challenge, step 303 comprises presenting a prompt comprising a secondary confirmation challenge. In one or more embodiments, the secondary confirmation challenge requires other user input at the user interface re-entering the electronic payment transaction amount in a different format. Other examples of secondary confirmation challenges were described above. Still others will be obvious to those of ordinary skill in the art having the benefit of this disclosure.

Decision 304 determines whether other user input received by the user interface correctly answers the secondary confirmation challenge. Where it does, step 305 completes the electronic payment transaction. By contrast, where it does not, decision 306 determines whether a predefined number of secondary confirmation challenges have been failed. Where they have not, another prompt can optionally be presented at step 303. Otherwise, one or more processors of the electronic device preclude execution of the electronic payment transaction associated with the electronic payment transaction amount at step 307. In one or more embodiments, this occurs when the other user input answering the secondary confirmation challenge fails to re-enter the electronic payment transaction amount in a different format.

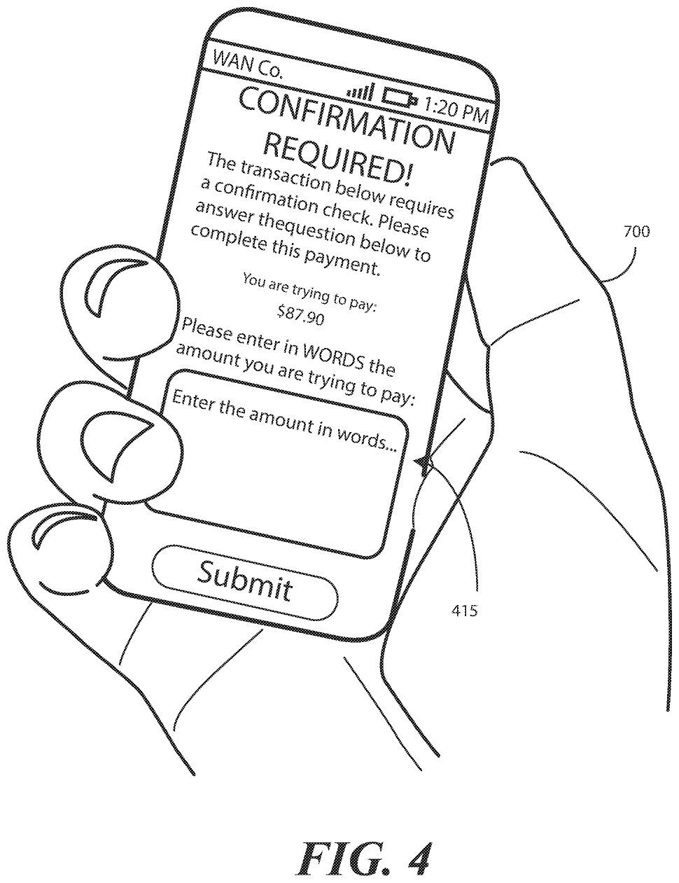

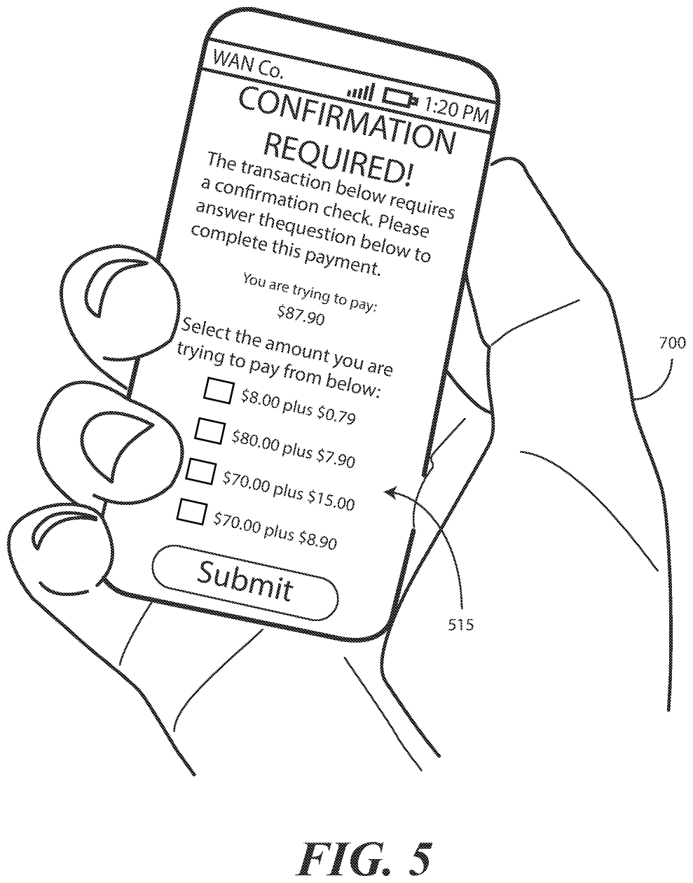

Turning now to FIGS. 4 and 5, illustrated therein are different examples of secondary confirmation challenges 415,515 in accordance with one or more embodiments of the disclosure. While the secondary confirmation challenge (115) of FIG. 1 presented a list of electronic payment transaction amounts in words, the secondary confirmation challenges 415,515 of FIGS. 4-5 take different forms.

Beginning with FIG. 4, in this example the secondary confirmation challenge 415 asks the patron 700 to enter the electronic payment transaction amount in words. Accordingly, the patron 700 would enter “eight dollars and seventy-nine cents” to answer the secondary confirmation challenge 415. If the patron did not enter “eighty-seven dollars and ninety cents,” the electronic payment transaction defining this electronic payment transaction amount would be precluded.

By contrast, the secondary confirmation challenge 515 of FIG. 5 asks the patron 700 to select the electronic payment transaction amount from a list listing various electronic payment transaction amounts as math equations. Unless the patron 700 selected the second option on the list, the electronic payment transaction associated with the electronic payment transaction amount would be precluded from completion. Again, the examples of FIGS. 1, 4, and 5 are illustrative only, as numerous others will be obvious to those of ordinary skill in the art having the benefit of this disclosure.

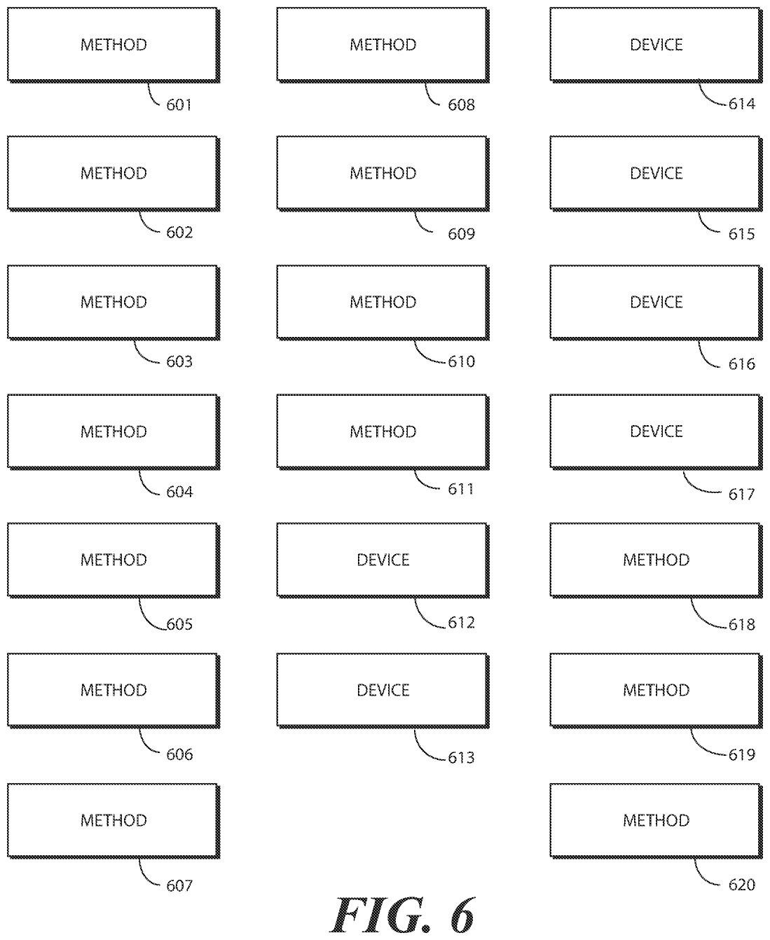

Turning now to FIG. 6, illustrated therein are various embodiments of the disclosure. The embodiments of FIG. 6 are shown as labeled boxes in FIG. 6 due to the fact that the individual components of these embodiments have been illustrated in detail in FIGS. 1-5, which precede FIG. 6. Accordingly, since these items have previously been illustrated and described their repeated illustration is no longer essential for a proper understanding of these embodiments. Thus, the embodiments are shown as labeled boxes.

At 601, a method in an electronic device comprises receiving, at a user interface, user input requesting an electronic payment transaction and defining an electronic payment transaction amount. At 601, the method comprises determining, by one or more processors operable with the user interface, whether the electronic payment transaction amount triggers a secondary confirmation operation.

At 601, when the electronic payment transaction amount triggers the secondary confirmation operation, the method comprises presenting, by the one or more processors on the user interface, a prompt comprising a secondary confirmation challenge. At 601, the method comprises receiving, at the user interface, other user input answering the secondary confirmation challenge.

At 601, when the user input answering the secondary confirmation challenge correctly answers the secondary confirmation challenge, the method comprises completing, by the one or more processors, the electronic payment transaction. At 601, when the user input answering the secondary confirmation challenge incorrectly answers the secondary confirmation challenge, the method comprises precluding, by the one or more processors, completion of the electronic payment transaction.

At 602, the secondary confirmation challenge of 601 requests the electronic payment transaction amount be entered in words. At 603, the secondary confirmation challenge of 601 lists a plurality of user selectable amounts spelled out in words, with one user selectable amount of the plurality of user selectable amounts spells out the electronic payment transaction amount in the words and other user selectable amounts of the plurality of user selectable amounts spell out transaction amounts other than the electronic payment transaction amount in the words. At 604, the secondary confirmation challenge of 601 lists a plurality of user selectable math equations, with one user selectable math equation the plurality of user selectable math equations has a sum equal to the electronic payment transaction amount and other user selectable math equations of the plurality of user selectable math equations have other sums that are different from the electronic payment transaction amount.

At 605, the method of 601 determines whether the electronic payment transaction amount triggers a secondary confirmation operation by determining whether the electronic payment transaction amount exceeds a predefined threshold. At 606, the method of 601 determines whether the electronic payment transaction amount triggers a secondary confirmation operation by determining whether the electronic payment transaction amount exceeds an average electronic payment transaction amount.

At 607, the method of 601 determines whether the electronic payment transaction amount triggers a secondary confirmation operation by determining whether the electronic payment transaction is requested at a predetermined time of day. At 608, the method of 601 determines whether the electronic payment transaction amount triggers a secondary confirmation operation by determining whether the electronic payment transaction is requested while the electronic device is situated in a predefined location. At 609, the method of 601 determines whether the electronic payment transaction amount triggers a secondary confirmation operation by determining whether the electronic payment transaction is directed to a recipient to whom previous electronic payment transactions have occurred.

At 610, the method of 601 further comprises determining of a predefined number of secondary confirmation challenges has been exceeded by presentation of the prompt comprising the secondary confirmation challenge. At 610, the precluding the completion of the electronic payment transaction occurs when the predefined number of secondary confirmation challenges fails to be exceeded by presentation of the prompt comprising the secondary confirmation challenge. At 610, when the predefined number of secondary confirmation challenges is exceeded by the presentation of the prompt comprising the secondary confirmation challenge, the method further comprises presenting, by the one or more processors on the user interface, another secondary confirmation challenge that is different from the secondary confirmation challenge. At 611, each secondary confirmation challenge presented at 601 is different from any previously presented secondary confirmation challenge.

At 612, an electronic device comprises a user interface, a communication device, and one or more processors operable with the user interface and the communication device. At 612, the one or more processors are configured to, in response to the user interface receiving user input requesting an electronic payment transaction and defining an electronic payment transaction amount, present a secondary confirmation challenge questioning the electronic payment transaction amount and preclude the electronic payment transaction from occurring when other user input received by the user interface in response to presentation of the secondary confirmation challenge fails the secondary confirmation challenge.

At 613, the secondary confirmation challenge of 612 presents a list of user selectable options with only one user selectable option of the list corresponding to the electronic payment transaction amount. At 614, the user selectable options of 613 comprise math equations. At 615, the user selectable options of 613 comprise transaction amounts spelled out in words.

At 616, the secondary confirmation challenge of 612 differs for each electronic payment transaction. At 617, the one or more processors of 612 are further configured to one of: present, on the user interface, another secondary confirmation challenge when the other user input received by the user interface in response to presentation of the secondary confirmation challenge fails the secondary confirmation challenge or change, by the one or more processors, the electronic payment transaction amount when the other user input received by the user interface in response to presentation of the secondary confirmation challenge fails the secondary confirmation challenge.

At 618, a method in an electronic device comprises receiving, by a user interface, user input defining an electronic payment transaction amount. At 618, the method comprises determining, by one or more processors operable with the user interface, whether the electronic payment transaction amount meets a predefined criterion.

At 618, when the electronic payment transaction amount meets the predefined criterion, the method comprises presenting, by the one or more processors on the user interface, a secondary confirmation challenge requiring other user input at the user interface re-entering the electronic payment transaction amount in a different format. At 618, the method comprises precluding, by the one or more processors, execution of an electronic payment transaction associated with the electronic payment transaction amount when the other user input fails to re-enter the electronic payment transaction amount in the different format.

At 619, the different format of 618 is in words. At 620, the different format of 618 comprises a selection from a list of words or math equations.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, at a user interface, user input requesting an electronic payment transaction and defining an electronic payment transaction amount;
determining, by one or more processors operable with the user interface, whether the electronic payment transaction amount triggers a secondary confirmation operation;
when the electronic payment transaction amount triggers the secondary confirmation operation, presenting, by the one or more processors on the user interface, a prompt comprising a secondary confirmation challenge;
receiving, at the user interface, other user input answering the secondary confirmation challenge;
when the user input answering the secondary confirmation challenge correctly answers the secondary confirmation challenge, completing, by the one or more processors, the electronic payment transaction; and
when the user input answering the secondary confirmation challenge incorrectly answers the secondary confirmation challenge, precluding, by the one or more processors, completion of the electronic payment transaction.

2. The method of claim 1, wherein the secondary confirmation challenge requests the electronic payment transaction amount be entered in words.

3. The method of claim 1, wherein the secondary confirmation challenge lists a plurality of user selectable amounts spelled out in words, with one user selectable amount of the plurality of user selectable amounts spells out the electronic payment transaction amount in the words and other user selectable amounts of the plurality of user selectable amounts spell out transaction amounts other than the electronic payment transaction amount in the words.

4. The method of claim 1, wherein the secondary confirmation challenge lists a plurality of user selectable math equations, with one user selectable math equation the plurality of user selectable math equations has a sum equal to the electronic payment transaction amount and other user selectable math equations of the plurality of user selectable math equations have other sums that are different from the electronic payment transaction amount.

5. The method of claim 1, wherein the determining whether the electronic payment transaction amount triggers a secondary confirmation operation comprises determining whether the electronic payment transaction amount exceeds a predefined threshold.

6. The method of claim 1, wherein the determining whether the electronic payment transaction amount triggers a secondary confirmation operation comprises determining whether the electronic payment transaction amount exceeds an average electronic payment transaction amount.

7. The method of claim 1, wherein the determining whether the electronic payment transaction amount triggers a secondary confirmation operation comprises determining whether the electronic payment transaction is requested at a predetermined time of day.

8. The method of claim 1, wherein the determining whether the electronic payment transaction amount triggers a secondary confirmation operation comprises determining whether the electronic payment transaction is requested while the electronic device is situated in a predefined location.

9. The method of claim 1, wherein the determining whether the electronic payment transaction amount triggers a secondary confirmation operation comprises determining whether the electronic payment transaction is directed to a recipient to whom previous electronic payment transactions have occurred.

10. The method of claim 1, further comprising determining of a predefined number of secondary confirmation challenges has been exceeded by presentation of the prompt comprising the secondary confirmation challenge, wherein:
the precluding the completion of the electronic payment transaction occurs when the predefined number of secondary confirmation challenges fails to be exceeded by presentation of the prompt comprising the secondary confirmation challenge; and
when the predefined number of secondary confirmation challenges is exceeded by the presentation of the prompt comprising the secondary confirmation challenge, the method further comprises presenting, by the one or more processors on the user interface, another secondary confirmation challenge that is different from the secondary confirmation challenge.

11. The method of claim 1, wherein each secondary confirmation challenge presented is different from any previously presented secondary confirmation challenge.

12. An electronic device, comprising:
a user interface;
a communication device; and
one or more processors operable with the user interface and the communication device;
wherein the one or more processors are configured to, in response to the user interface receiving user input requesting an electronic payment transaction and defining an electronic payment transaction amount, present a secondary confirmation challenge questioning the electronic payment transaction amount and preclude the electronic payment transaction from occurring when other user input received by the user interface in response to presentation of the secondary confirmation challenge fails the secondary confirmation challenge.

13. The electronic device of claim 12, wherein the secondary confirmation challenge presents a list of user selectable options with only one user selectable option of the list corresponding to the electronic payment transaction amount.

14. The electronic device of claim 13, wherein the user selectable options comprise math equations.

15. The electronic device of claim 13, wherein the user selectable options comprise transaction amounts spelled out in words.

16. The electronic device of claim 12, wherein the secondary confirmation challenge differs for each electronic payment transaction.

17. The electronic device of claim 12, wherein the one or more processors are further configured to one of:
present, on the user interface, another secondary confirmation challenge when the other user input received by the user interface in response to presentation of the secondary confirmation challenge fails the secondary confirmation challenge; or
change, by the one or more processors, the electronic payment transaction amount when the other user input received by the user interface in response to presentation of the secondary confirmation challenge fails the secondary confirmation challenge.

18. A method in an electronic device, the method comprising:
receiving, by a user interface, user input defining an electronic payment transaction amount;
determining, by one or more processors operable with the user interface, whether the electronic payment transaction amount meets a predefined criterion;
when the electronic payment transaction amount meets the predefined criterion, presenting, by the one or more processors on the user interface, a secondary confirmation challenge requiring other user input at the user interface re-entering the electronic payment transaction amount in a different format; and
precluding, by the one or more processors, execution of an electronic payment transaction associated with the electronic payment transaction amount when the other user input fails to re-enter the electronic payment transaction amount in the different format.

19. The method of claim 18, wherein the different format is in words.

20. The method of claim 18, wherein the different format comprises a selection from a list of words or math equations.
